(19) United States
(12) Patent Application Publication
(10) Pub. No.: US 2004/0240224 A1
(43) Pub. Date: Dec. 2, 2004

(54) [POWER ADJUSTABLEG HEADLIGHT SYSTEM]

(76) Inventors: TAI-AN CHIANG, TAIPEI (TW); TAI-LIANG LIN, TAIPEI (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/249,993

(22) Filed: May 26, 2003

(51) Int. Cl. F21V 19/02

(52) U.S. Cl. 362/523; 362/520

(57) ABSTRACT

A power adjustable headlight system and a related method is provided. The system comprises a lens for receiving a light intensity from a low-beam illumination area; a low-beam sensor for detecting a light intensity from the low-beam illumination area; and a power control unit for receiving a signal from the low-beam sensor and for applying a control signal to the low beam to adjust the light intensity. The system further comprises a high-beam sensor for detecting a light intensity from a high-beam illumination area, and also controlled by the power control unit. A battery for applying an external power to the headlight system is available. Therefore, the headlight system can adjust the light intensities of the low beam and the high beam according to the detection of the light intensities from the environment automatically.

### BACKGROUND OF INVENTION

1. Field of the Invention

The present invention generally relates to a headlight system of a motor vehicles or other road vehicles. More particularly, the present invention relates to a headlight system of a motor vehicles or other road vehicles for adjusting the light intensities of a high beam and a low beam.

2. Description of the Related Art

In general, a headlight of a road vehicle includes a low beam and a high beam. FIG. 1 is a side view of the light paths of a low beam and a high beam, and FIG. 2 is a top view of the light paths of a low beam and a high beam. Referring to FIG. 1, a low beam having light paths 104 from a headlight 102 is used when the speed of the vehicle is low or a near-field illumination is needed for the driver, in which the vehicle is on the ground 108. Oppositely, a high beam having light paths 106 from a headlight 102 is used when the speed of the vehicle is high or a far-field illumination is needed for the driver. Referring to FIG. 2, a low beam having light paths 104 from a headlight 102 is used when the speed of the vehicle is low or a wider-angle and near-field illumination is needed for the driver, and also a high beam having light paths 106 from a headlight 102 is used when the speed of the vehicle is high or a narrower-angle and far-field illumination is needed for the driver. Most importantly, except for the view angle and distance, the illumination intensities of the low beam and the high beam is also an important factor for the safety of the driver. Thus, a power adjustable headlight system for adjusting the light intensities of the low beam and the high beam is provided in the present invention.

### SUMMARY OF INVENTION

Accordingly, the purpose of the present invention is to provide a power adjustable headlight system for adjusting the light intensities of the low beam and the high beam.

One of objects of the present invention is to provide an automatically power adjustable headlight system for adjusting the light intensities of the low beam and the high beam, in which the headlight system can adjust the light intensities of the low beam and the high beam according to the detection of the light intensities from the environment automatically.

In order to achieve the above objects and other advantages of the present invention, some embodiments of a power adjustable headlight system of the present invention is provided. In a preferred embodiment of the present invention, a power adjustable headlight system connected to a headlight switch of a vehicle for adjusting light intensity, comprising a lens for receiving a light intensity from a low-beam illumination area; a low-beam sensor for detecting a light intensity from the low-beam illumination area; wherein the low-beam sensor is mounted on an off-axial region of the lens; and a power control unit for receiving a signal from the low-beam sensor and for applying a control signal to the low beam to adjust the light intensity.

Preferably, in the power adjustable headlight system described above, the low-beam sensor is mounted on the off-axial region above the axis, which locates opposing to the ground.

Preferably, the power adjustable headlight system described above further comprises a high-beam sensor for detecting a light intensity from a high-beam illumination area, and wherein the high-beam sensor is mounted on a near-axial region of the lens.

Preferably, the power adjustable headlight system described above further comprises a high-beam sensor for detecting the light intensity from a high-beam illumination area, and wherein the high-beam sensor is mounted along the axis of the lens and near the focusing point of the lens.

Preferably, the power adjustable headlight system described above further comprises a battery for applying an external power to the headlight system.

Preferably, in the power adjustable headlight system described above, the headlight switch comprises a light on/off switch and a low/high beam switch.

Preferably, in the power adjustable headlight system described above, the lens comprises a single lens.

Preferably, in the power adjustable headlight system described above, the lens comprises a fly-eye lens, wherein the low-beam sensor is mounted near a focusing point of one of the fly-eye lens; and further comprises a high-beam sensor mounted near a focusing point of another one of the fly-eye lens. Preferably, the low-beam sensor and the high-beam sensor are different or the same.

In another preferred embodiment of the present invention, a power adjustable headlight system connected to a headlight switch of a vehicle for adjusting light intensity, comprising a lens for receiving a light intensity from a low-beam illumination area; a low-beam sensor for detecting a light intensity from the low-beam illumination area; wherein the low-beam sensor is mounted along the axial of the lens, and located between the lens and the focusing point of the lens; and a power control unit for receiving a signal from the low-beam sensor and for applying a control signal to the low beam to adjust the light intensity. Preferably, the power adjustable headlight system further comprises a battery for applying an external power to the headlight system.

In order to achieve the above objects and other advantages of the present invention, some embodiments of a power adjustable method of a headlight of the present invention is provided. In a preferred embodiment of the present invention, a method for adjusting light intensities of a headlight of a vehicle, comprising the steps of receiving a low beam from a low-beam illumination area, focusing the low beam and detecting the intensity of the low beam; comparing the low-beam intensity from a preset low-beam intensity; and adjusting the low-beam intensity according to the difference between the low-beam intensity and the preset low-beam intensity.

Preferably, in the method described above, the method further comprises the steps of receiving a high beam from a high-beam illumination area, focusing the high beam and detecting the intensity of the high-beam; comparing the high-beam intensity from a preset high-beam light intensity; and adjusting the high-beam intensity according to the difference between the high-beam intensity and the preset high-beam intensity. Preferably, the detection of the low beam and the high beam are separately or the detection of the low beam and the high beam are simultaneously and at the same location.

Accordingly, by the system and method described above, a power adjustable headlight system and method for adjusting the light intensities of the low beam and the high beam are achieved in the present invention. More particularly, an automatically power adjustable headlight system and method for adjusting the light intensities of the low beam and the high beam, in which the headlight system can adjust the light intensities of the low beam and the high beam according to the detection of the light intensities from the environment automatically are also achieved in the present invention.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a side view of the light paths of a low beam and a high beam.

FIG. 2 is a top view of the light paths of a low beam and a high beam.

FIG. 3 is a cross-sectional view of the light paths of a low beam and a high beam of a preferred embodiment of the present invention.

FIG. 4 is a diagram, schematically illustrating a power adjustable headlight system of one preferred embodiment of the present invention.

FIG. 5 is a diagram, schematically illustrating a power adjustable headlight system of another preferred embodiment of the present invention.

FIG. 6 is a cross-sectional view, schematically illustrating the light paths of a low beam and a high beam of an embodiment of the present invention.

FIG. 7 is a diagram, schematically illustrating a power adjustable headlight system of another preferred embodiment of the present invention.

FIG. 8 is a diagram, schematically illustrating a power adjustable headlight system of one another preferred embodiment, of the present invention.

FIG. 9 is a cross-sectional view, schematically illustrating the light paths of a low beam and a high beam of an embodiment of the present invention.

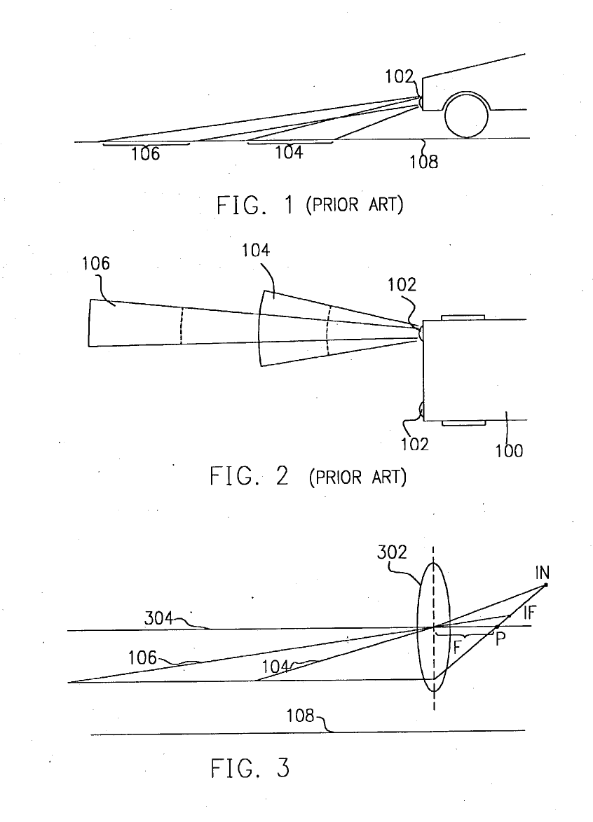

### DETAILED DESCRIPTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. Moreover, each embodiment described and illustrated herein includes its complementary conductivity type embodiment as well.

Referring to FIG. 3, FIG. 3 is a sectional view of the light paths of a low beam and a high beam of a preferred embodiment of the present invention. A lens 302 having a main axis 304 and a focal length F is provided for receiving a low beam having a light pass 104 from a low-beam illumination area, and for receiving a high beam having a light pass 106 from a high-beam illumination area. In the embodiment, the high-beam sensor may be mounted on a near-axial region of the lens, i.e., a region along the axis 304 and about the focusing point P, or a region just a little above the axis 304 and near the point IF, and the low-beam sensor may be mounted on an off-axial region of an optical axis of the lens, e.g., a region off the axis 304 and near the point IN. In other words, the low-beam sensor is not on the optical axis of the lens. According to the features of the low-beam, the off-axial region is, for example, above the optical axis, in which the ground is defined as the lower side of the off axis.

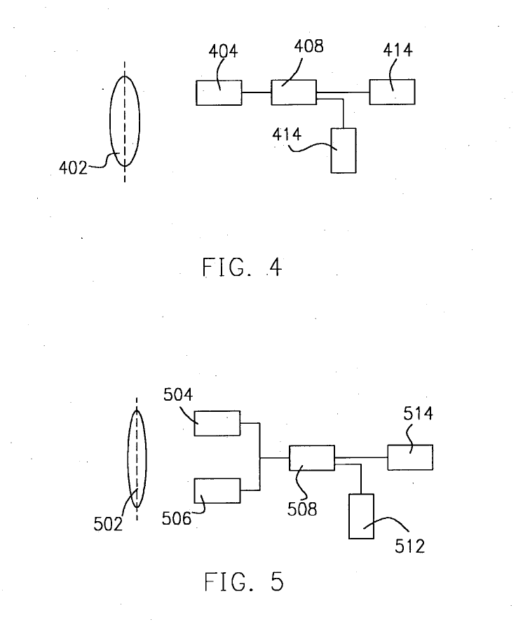

FIG. 4 is a diagram illustrating a power adjustable headlight system of one preferred embodiment of the present invention. Referring to FIG. 4, low-beam sensor 404 mounted after a lens 402 is connected to a power control unit 408. Referring to FIG. 3 again, the low-beam sensor 404 is mounted on a region near the point IN and provided for detecting the light intensity from the low-beam illumination area 104. The power control unit 408 shown in FIG. 4 is provided for receiving a signal corresponding to the light intensity detected from the low-beam sensor and for applying a control signal to the headlight to adjust the light intensity of the headlight system of the vehicle. A battery 412 for applying an external power to the headlight system may be provided, and the power control unit 408 may be connected to a headlight switch 414 including, but not limited to, a light on/off switch and a low/high beam switch.

FIG. 5 is a diagram illustrating a power adjustable headlight system of another preferred embodiment of the present invention. Referring to FIG. 5, low-beam sensor 504 and a high-beam sensor 506 mounted after a lens 502 is connected to a power control unit 508. Referring to FIG. 3, the low-beam sensor 504 is mounted on a region near the point IN and provided for detecting the light intensity from the low-beam illumination area 104, and the high-beam sensor 506 is mounted on a region near the point IF and provided for detecting the light intensity from the high-beam illumination area 106. The power control unit 508 shown in FIG. 5 is provided for receiving signals corresponding to the light intensity detected from the low-beam and high-beam sensor and for applying a control signal to the headlight to adjust the light intensity of the headlight system of the vehicle. A battery 512 for applying an external power to the headlight system may be provided, and the power control unit 508 may be connected to a headlight switch 514 including, but not limited to, a light on/off switch and a low/high beam switch.

Hereinafter, another type of a power adjustable headlight system of an embodiment of the present invention is described.

Referring to FIG. 6, FIG. 6 is a sectional view of the light paths of a low beam and a high beam of an embodiment of the present invention. A fly-eye lens 601 comprising at least a lens 602 and a lens 603 is provided. The fly-eye lens 601 has a main axis 600 paralleling to the ground 108. Referring to FIG. 3, the angle between the light paths of high beam 106 and the main axis 304 is smaller than the angle between the light paths of low beam 104 and the main axis 304. Also in FIG. 6, the lens 602 having a main axis 612 paralleling to the axis 600 is provided for receiving a light from a high-beam illumination area 106. Also and the lens 603 having a main axis 613 crossing the axis 600 is provided for receiving a light from a low-beam illumination area 104. In the embodiment hereinafter, the high-beam sensor may be mounted on a region near the focusing point F1, and the low-beam sensor may be mounted on a region near the focusing point F2.

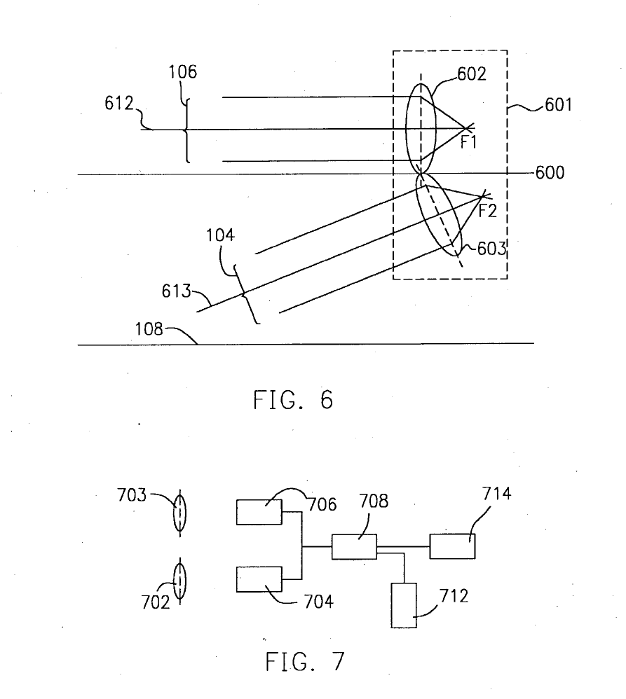

FIG. 7 is a diagram illustrating a power adjustable headlight system of another preferred embodiment of the present invention. Referring to FIG. 7, low-beam sensor 704 mounted after a lens 702 and a high-beam sensor 706 mounted after a lens 703 is connected to a power control unit 708. Referring to FIG. 6, the high-beam sensor 706 is mounted on a region near the focusing point F1 and provided for detecting the light intensity from the high-beam illumination area, and the low-beam sensor 704 is mounted on a region near the focusing point F2 and provided for detecting the light intensity from the low-beam illumination area. The power control unit 708 shown in FIG. 7 is provided for receiving signals corresponding to the light intensity detected from the low-beam and high-beam sensor and for applying a control signal to the headlight to adjust the light intensity of the headlight system of the vehicle. A battery 712 for applying an external power to the headlight system may be provided, and the power control unit 708 may be connected to a headlight switch 714 including, but not limited to, a light on/off switch and a low/high beam switch.

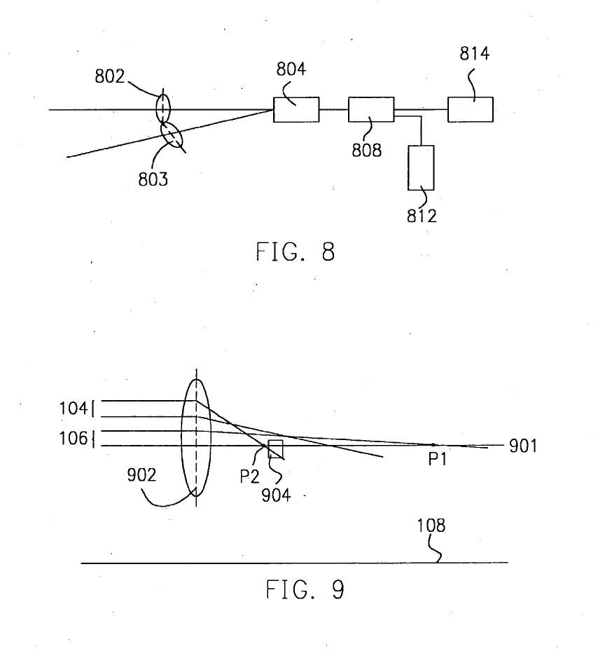

FIG. 8 is a diagram illustrating a power adjustable headlight system of one another preferred embodiment of the present invention. Referring to FIG. 8, a sensor 804 mounted after a lens 802 and a lens 803 is connected to a power control unit 808. Referring to FIG. 8, the sensor 804 is mounted on a region near the focusing point of the lens 802 and the lens 803 and is provided for detecting the light intensity from the high-beam illumination area and the low-beam illumination area. The power control unit 808 is provided for receiving signals corresponding to the light intensity detected from the low-beam and high-beam sensor and for applying a control signal to the headlight to adjust the light intensity of the headlight system of the vehicle. A battery 812 for applying an external power to the headlight system may be provided, and the power control unit 808 may be connected to a headlight switch 814 including, but not limited to, a light on/off switch and a low/high beam switch.

Hereinafter, one another type of a power adjustable headlight system of an embodiment of the present invention is described.

Referring to FIG. 9, FIG. 9 is a sectional view of the light paths of a low beam and a high beam of an embodiment of the present invention. A lens 902 having a main axis 901 paralleling to the ground 108 is provided, and light paths from a high-beam illumination area 106 having a focusing point P1 and light paths from a low-beam illumination area 104 having a focusing point P2. According to a spherical aberration, the focusing length P1 is larger than the focusing length of P2, and the focusing lens of the lens 902 is usually defined as P1. Therefore a sensor 904 is mounted near the point P2, i.e., between the defined focusing point P1 and the lens 902 in order to receive the light mostly from the low-beam illumination area and merely from the high-beam illumination area.

Hereinafter, a method for adjusting the light intensity of a headlight system of a preferred embodiment of the present invention is described.

In a preferred embodiment of the invention, a method comprises the steps of receiving a low beam from a low-beam illumination area, focusing the low beam and detecting the intensity of the low beam; comparing the low-beam intensity from a preset low-beam intensity; and adjusting the low-beam intensity according to the difference between the low-beam intensity and the preset low-beam intensity.

Preferably, the method described above comprises the steps of receiving a high beam from a high-beam illumination area, focusing the high beam and detecting the intensity of the high-beam; comparing the high-beam intensity from a preset high-beam light intensity; and adjusting the high-beam intensity according to the difference between the high-beam intensity and the preset high-beam intensity.

Preferably, in the method described above, the detection of the low beam and the high beam are separately, or the detection of the low beam and the high beam are simultaneously and at the same location.

Accordingly, by the system and method described above, a power adjustable headlight system and method for adjusting the light intensities of the low beam and the high beam are achieved in the present invention. More particularly, an automatically power adjustable headlight system and method for adjusting the light intensities of the low beam and the high beam, in which the headlight system can adjust the light intensities of the low beam and the high beam according to the detection of the light intensities from the environment automatically are also achieved in the present invention.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A power adjustable headlight system connected to a headlight switch of a vehicle for adjusting light intensity, comprising:
a lens for receiving a light intensity from a low-beam illumination area;
a low-beam sensor for detecting the light intensity from the low-beam illumination area through the lens; wherein the low-beam sensor is mounted on an off-axial region of the lens; and
a power control unit for receiving a signal from the low-beam sensor and accordingly adjusting a light beam intensity for a low beam of the vehicle.

2. The power adjustable headlight system of claim 1, wherein the low-beam sensor is mounted on the off-axial region above an optical axis of the lens, opposing to a ground.

3. The power adjustable headlight system of claim 1, wherein the power adjustable headlight system further comprises a high-beam sensor for detecting a light intensity from a high-beam illumination area, and wherein the high-beam sensor is mounted on a near-axial region of the lens.

4. The power adjustable headlight system of claim 1, wherein the power adjustable headlight system further comprises a high-beam sensor for detecting the light intensity from a high-beam illumination area, and wherein the high-beam sensor is mounted along the axis of the lens and near the focusing point of the lens.

5. The power adjustable headlight system of claim 1, wherein the power adjustable headlight system further comprises a battery for applying an external power to the headlight system.

6. The power adjustable headlight system of claim 1, wherein the headlight switch comprises a light on/off switch and a low/high beam switch.

7. The power adjustable headlight system of claim 1, wherein the lens comprises a single lens.

8. The power adjustable headlight system of claim 1, wherein the lens comprises a fly-eye lens, wherein the low-beam sensor is mounted near a focusing point of one of the fly-eye lens; and further comprises a high-beam sensor mounted near a focusing point of another one of the fly-eye lens.

9. The power adjustable headlight system of claim 8, wherein the low-beam sensor and the high-beam sensor are different.

10. The power adjustable headlight system of claim 8, wherein the low-beam sensor and the high-beam sensor are the same.

11. A power adjustable headlight system connected to a headlight switch of a vehicle for adjusting light intensity, comprising:
a lens for receiving a light intensity from a low-beam illumination area;
a low-beam sensor for detecting a light intensity from the low-beam illumination area through the lens; wherein the low-beam sensor is mounted along an optical axis of the lens, and located between the lens and the focusing point of the lens; and
a power control unit for receiving a signal from the low-beam sensor and to control an beam intensity of a low beam of the vehicle.

12. The power adjustable headlight system of claim 11, wherein the power adjustable headlight system further comprises a battery for applying an external power to the headlight system.

13. A method for adjusting light intensities of a headlight of a vehicle, comprising:
receiving a low beam from a low-beam illumination area, focusing the low beam and detecting the intensity of the low beam;
comparing the low-beam intensity from a preset low-beam intensity; and
adjusting the low-beam intensity according to the difference between the low-beam intensity and the preset low-beam intensity.

14. The method of claim 13, wherein the method further comprises the steps of:
receiving a high beam from a high-beam illumination area, focusing the high beam and detecting the intensity of the high-beam;
comparing the high-beam intensity from a preset high-beam light intensity; and
adjusting the high-beam intensity according to the difference between the high-beam intensity and the preset high-beam intensity.

15. The method of claim 14, wherein the detection of the low beam and the high beam are separately.

16. The method of claim 14, wherein the detection of the low beam and the high beam are simultaneously and at the same location.
